(19) United States
(12) Patent Application Publication
(10) Pub. No.: US 2023/0047852 A1
(43) Pub. Date: Feb. 16, 2023

(54) PROJECTILE/TOY THROWING DEVICE HAVING INTERCHANGEABLE PROJECTILE/TOY RETENTION AND RELEASE MECHANISM

(71) Applicant: Pete Giancola, Jordan, MN (US)

(72) Inventor: Pete Giancola, Jordan, MN (US)

(21) Appl. No.: 17/805,625

(22) Filed: Jun. 6, 2022

Related U.S. Application Data
(60) Provisional application No. 63/231,889, filed on Aug. 11, 2021.

(51) Int. Cl. A63B 65/12

(52) U.S. Cl. CPC A63B 65/12; A01K 15/025

(57) ABSTRACT

An improved object or projectile throwing device may include a handle and base having an element configured for improved projectile retention and release. The handle may be removably attached to a coupler, where the couple may include a receptacle or socket that is attached to the handle. Various bases include different projectile retention and release elements that configured secure or retain different types of objects or projectiles, thereby enabling the projectile throwing device to be adaptable to throw a variety of objects. Two or more handles of different lengths can be selectively coupled to a base of the projectile throwing device, such as to adapt the throwing distance, or the effort required to throw an object, to the throwing strength or abilities of an animal caregiver or to facilitate throwing of objects of different weight or density.

### CLAIM OF PRIORITY

This application claims priority to and the benefit of U.S. Provisional Patent Application No. 63/231,889, filed on 11 Aug. 2021, which is incorporated herein by reference in its entirety.

### FIELD OF THE DISCLOSURE

This document pertains generally, but not by way of limitation, to toys adapted for animals, more particularly, to a projectile or toy throwing device.

### BACKGROUND

Pets or other animals, such as dogs or cats, may depend on their caregivers for entertainment, exercise, or other physical or mental development activity (hereinafter, “exercise”). An activity commonly used to exercise such animals includes throwing an object, such as a toy or tool, for the animal to retrieve. In an example, a dog owner may exercise his dog by repeatedly throwing a ball or stick and encouraging the animal to chase after the object, secure it, and return it to the owner. The physical or mental benefit experienced by animals from these fetching activities can depend on the distance and the number of times the object is thrown. Some animal caregivers, however, are not able to throw objects used to exercise their animals far enough or with enough repetition to sufficiently exercise these animals without overexerting or injuring themselves. These issues may be at least partially alleviated by throwing or fetching devices, such as described in U.S. Pat. No. 6,076,829A having an issue date Jun. 20, 2000, and which is titled “Launcher and Projectile Type Pet Toy” and names Mark J. Oblack as the inventor. The '829 patent describes, among other things, a “a ball throwing apparatus including an elongated shaft with a half-spherical structure attached to or formed at its distal end designed to easily engage and pick up a ball for throwing without having to touch the ball with your hand or fingers.” The devices described in the '829 patent, and other similar devices, are limited in type of objects that they can throw, the distances in which the objects can be thrown, or the amount of physical exertion required to adequately exercise animals using these devices.

### BRIEF DESCRIPTION OF THE DRAWINGS

FIGS. 1A and 1B illustrates an example of a projectile throwing device having interchangeable projectile retention and release elements.

FIG. 2 illustrates an example of profile view of a projectile throwing device having interchangeable projectile retention and release elements.

FIG. 3 illustrates an example of a coupling system for detachably coupling a handle of a projectile throwing device to interchangeable projectile retention and release element.

FIG. 4 illustrates an example of a base of a projectile throwing device including an interchangeable projectile retention and release element having at least two extensions and for securing a projectile.

FIG. 5 illustrates an example of a base of a projectile throwing device including an interchangeable projectile retention and release element having at least two curved extensions and for securing a projectile.

FIGS. 6A and 6B an example of a base of a projectile throwing device including an interchangeable projectile retention and release element having an angled extension for inserting into a projectile.

FIGS. 7A and 7B illustrates an example of a base of a projectile throwing device including an interchangeable projectile retention and release element having a scoop or cup region 730 for securing a projectile.

FIG. 8 illustrates an example of a model of a projectile throwing device 800.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

Aspects of the present disclosure include an object or projectile throwing device, system, or apparatus that overcomes or mitigates deficiencies in existing fetching or throwing devices. In an example, the projectile throwing device of the instant disclosure includes a handle and base having a projectile retention and release element. The handle is configured to be attached to, or to be detached from, the base through a coupler. In certain examples, the coupler includes a first element, such as a receptacle or socket, that is coupled or affixed to the handle. In another example, the coupler includes a second element, such as a plug, clip, or pin, that is coupled or attached to the base. The first and second elements of the coupler are configured to interface, or interlock, and separate without the use of tools to detachably couple the handle to the base. This enables a plurality of configurations of the projectile throwing device. In an example, a handle configured with a first element of the coupler can be coupled to one or more bases provided that each base is configured with a matching coupler element (e.g., second element of the coupler) for interfacing with the first element. In an example, each base includes different projectile retention and release elements that configured secure or retain different types of objects or projectiles, thereby enabling the projectile throwing device to be adaptable to throw a variety of dissimilar objects. In another example, two or more handles of different lengths can be selectively coupled to a base of the projectile throwing device, such as to adapt the throwing distance, or the effort required to throw an object, to the throwing strength or abilities of an animal caregiver or to facilitate throwing of objects of different weight or density. In an example, the base is configured to hold or retain an object to be thrown without the assistance from the handle.

The present disclosure uses the terms “object” and “projectile” interchangeably. These terms, as used herein, refer to, or include any projectile, object, device, toy, or tool that can be thrown and retrieved by an animal. Examples of such objects or projectiles include animal or children's toys, balls, sticks, branches, fruit, stuffed animals, sacks stuffed with sand or beans or the like, or any other suitable object such as rake, broom, shovel, or the like.

As used herein, the term “secure”, such as “to secure and object”, refers to exerting a holding force on the object such that the object can be held aloft against the weight or effect of gravity without slipping. The term secure can also refer to at least partially encapsulating an object in a container such that the container can be held aloft without the object falling out of the container.

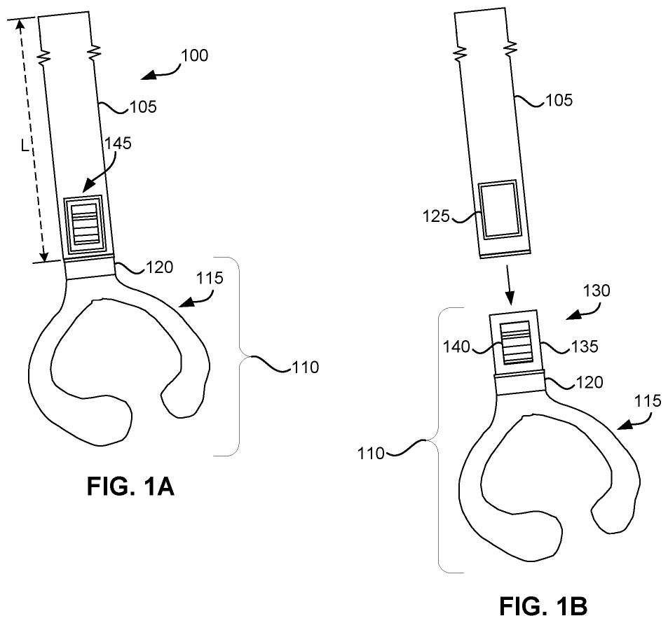

FIGS. 1A and 1B illustrates an example of a projectile throwing device 100 having interchangeable projectile retention and release elements. Projectile throwing device 100 includes a handle 105, a head or base 110, and a coupler 145. FIG. 1A illustrates an example of an integrated or assembled configuration of projectile throwing device 100, such as where handle 105 is coupled to base 110 by the coupler 145. FIG. 1B illustrates an example of projectile throwing device 100 where handle is detached or separated from base 105.

Handle 105 includes a length L of a rigid or flexible material that is configured to support base 110 and an object retained and released by base during a repetitive operation of securing, lifting, and throwing the object using projectile throwing device 100. In an example, handle 105 includes a shaft made of metal, wood, plastic, carbon fibre, rubber, or any other suitable natural or synthetic material. Handle 105, in various examples, is fabricated from, or made of, material used to construct hockey or lacrosse sticks, sports bats, or oars and boat paddles. In other examples, handle 105, is fabricated from, or made of, a handle of a tool, such as the handle of a rake, broom, shovel, or the like.

According to various examples, handle 105 includes a solid or hallow shaft having a length L. The length L of handle 105 can be selected or configured based on the preferences, throwing strength, or physical abilities of an animal caregiver or other user of projectile throwing device 100. In an example, the length L of handle 105 is at least 1 meter. In another example, the length L of handle is long enough to enable a user to secure of object disposed on the ground or floor in projectile throwing device 100 from an erect or standing position without bending. In another example, length L is selected to enable a user to throw an object an indicated distance.

According to various examples, handle 105 includes a coupling element 125 at a proximate end of its shaft, as described herein. Handle 105 may further include additional elements, such as a hand grip coupled to a distal end of the shaft or handle.

Base 110 includes coupling element 130 and projectile retention or release element 115. In an example, coupling element 130 includes plug element 135 of coupler 145 that is configured to interface with coupling element 125. Plug element 135 can include clip or button 140 that can be actuated or depressed to couple base 110 to, or to decouple the base from, handle 105. Projectile retention and release element 115 can include any device or structure that is configured to secure or retain an object, such as without manual manipulation of the object with a user's hand, and to release the object response to application of a force, such as a force exerted by a user whipping or swinging projectile throwing device 100 using a throwing motion. In an example, projectile retention and release element 115 includes a forked device having at least two straight or curved flexible extensions or arms that are configured to secure an object between the extensions by applying a compressive force to the object. In another example, projectile retention and release element 115 includes an angled device or structure having an extended or elongated region that is configured to secure an object by being at least partially inserted into a cavity within the object. In another example, projectile retention and release element 115 includes a device or structure having a cup, scoop, or partially enclosed platform region that is configured to secure an object by at least partially enclosing the object within the cup, scoop, or platform region. In another example, projectile retention and release element 115 includes a tool, such as a rake, broom, shovel, soil digger implement, or the like.

In some examples, base 110 or projectile retention and release element 115 form an interchangeable projectile retention and release element. In some examples, base 110, projectile retention and release element 115, or other components are formed using extrusion or injection molded processes.

According to various examples, base 110 or projectile retention and release element 115 is fabricated using a flexible material such as rubber, plastic, or other suitable natural or synthetic material. In some examples, base 110 or projectile retention and release element 115 fabricated using a rigid material, such as a hard plastic. In other examples, base 110 or projectile retention and release element 115 is fabricated using an elastomeric material or polymer having a Young's modulus that is high enough to enable the retention and release element to flex or deflect to accommodate or secure an object, but low enough to retain the object through the arc of a swinging motion until the apex or release point.

In some examples, base 110 includes a collar region 120 that is configured to interface with the proximate end of the handle 105 by providing a buffer or barrier between handle 105 and projectile retention and release element 115.

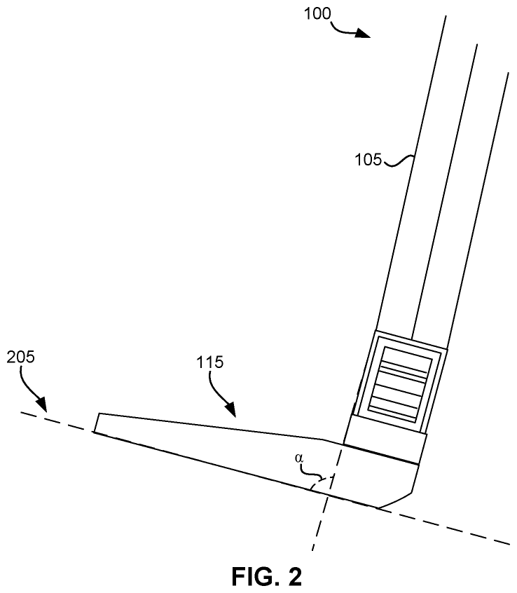

FIG. 2 illustrates an example of a profile view of the projectile throwing device 100. In various examples, as shown in FIG. 2, handle 105 forms an angle α with base 110 or projectile retention and release element 115. The angle α between the handle 105 and base 110 or projectile retention and release element 115 enables the projectile retention and release element 115 to lay flat or horizontal on the ground 205 while the handle 105 is held erect, or perpendicular to the ground. This can enable an animal caregiver or other user to retrieve or secure an object using projectile throwing device 100 without having to bend over. In an example, the angle α is between 45 and 90 degrees.

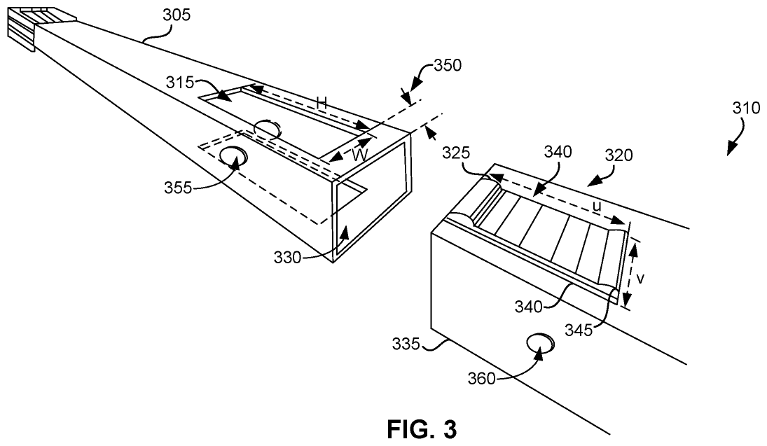

FIG. 3 illustrates an example of a coupling system for detachably coupling a handle 305 of a projectile throwing device to an interchangeable projectile retention and release element 310. Handle 305 is an example of handle 105 (FIG. 1) while projectile retention and release element 310 is an example of projectile retention and release element 110. Similarly, the coupling system is an example of coupler 145 (FIG. 1) and includes socket element 315 corresponding to socket element 125 and plug or coupling element 320 corresponding to coupling element 130. Although socket elements 125 or 315 are depicted on handles 105 or 305 and coupling element 130 and 320 are depicted on base 110 or 310, configurations of the projectile throwing devices described herein can have these elements reversed, such that socket elements 125 and 315 are disposed on bases 110 or 310, coupling element 130 and 320 are disposed on handle 105 and 305. Coupling elements 130 and 320 may also be used on one or more extension elements (not shown) placed between the bases 110 or 310 and the handle 105 and 305.

As shown in FIG. 3, handle 305 can include a hallow shaft. The shaft may be configured with socket element 315, wherein the socket element includes opposing openings (e.g., two openings) on opposite planar surfaces of the hallow shaft. In an example, each opening has a width W that is ¾ of an inch and a length H that is

$$1 \frac{1}{8}$$

of inches and is disposed at distance 350 of 1 inch from the opening of cavity 330.

Coupling element 320, can include plug element 335, wherein the plug element includes buttons (e.g., two buttons) on opposing sides of the coupling element. Each button corresponds to one of the openings in socket element 315 and may be actuated or depressed in a coupling operation where the handle 305 is joined or coupled to base 310 by inserting plug element 335 into cavity 330. Plug element 335, according to various examples, includes a hallow shaft having slots 340 extending from proximate ends of the buttons towards buckle release element 325. In an example, slots 340 releases or decouples three sides of each button from the plug element 335 to, for example, enable the buttons to be depressed into the hollow center of the plug element. In an example, each button has a width V that is ⅝ of an inch and a length u that is 1 inch.

In operation, handle 305 is coupled to base 310 by inserting plug element 335 into cavity 330 until release element 325 and locking element 345 are exposed or visible within the openings in socket 315. Handle 305 is decoupled or separated from base 310 by depressing release element 325 on each side of plug element 335 and exerting force on each component to pull them apart.

Although a buckle or snap-based coupling system described in the instant disclosure, any other suitable techniques or coupling system can be used to detachably couple the handle and base, or interchangeable projectile retention and release element elements of the projectile throwing devices described herein. In an example, the coupling system includes a buckle, and the socket and plug components can include interlocking fittings of the buckle. In another example, the coupling system can include threaded socket and plug fittings adapted to screw together or a pin type system through the detachable device. In another example, a threaded coupling system may be used to provide a telescoping (e.g., user-adjustable) length that can be secured by tightening the threaded coupling. In yet another example, the coupling system includes a threaded fitting, such as a screw or bolt that is configured to fit through a hole drilled through the handle and the base or retention and release mechanism collar of the projectile throwing device to maintain/retain the retention and release mechanism in the handle.

The coupling system, in various examples, include openings 355 and 360 in handle 305 and base 310. Openings 355 or 360, in some examples, extend through opposing sides or surfaces of handle 305 and base 310. In some examples, openings 355 and 360 align when coupling element 320 or base 310 in inserted into cavity 330, such that a pin can be inserted into opening 355 and 360, such as to lock or maintain/retain projectile retention and base 310 release element or mechanism in handle 305. In an example, coupling element 320 may include a twist lock mechanism to lock the handle 305 and base 310 together without requiring a pin. One or more of these coupling elements 320 may prevent or limit destruction of, or damage to, the projectile throwing device through forceable separation of the handle 305 and the base 310.

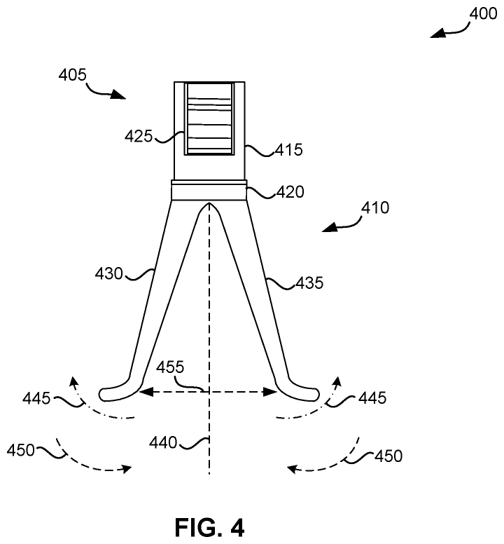

FIG. 4 illustrates an example of a base 400 of a projectile throwing device including an interchangeable projectile retention and release element 410 having at least two extensions 430 and 435 for securing a projectile. The projectile throwing device can be an example of any of the projectile throwing devices described herein, such as the projectile throwing device 100. As shown, base 400 can include coupling element 405, corresponding to coupling element 130, and projectile retention and release element 410 corresponding to the projectile retention and release element 115. In an example, coupling element 405 includes plug element 415 or clip or button element 425. The retention and release element 410, in various examples, include collar 420 and extensions 430 and 435. In an example, extensions 430 and 435 have first and second ends, where the first ends affix the extensions to collar 420 and the second ends include distal ends of the extensions on opposing sides of a common or shared axis 440. In some examples, extensions 430 and 435 extend parallel to each other on opposing sides of the axis 440. In other examples, extensions 430 and 435 extend in diverging directions (e.g., diverging from each other) on opposing sides of the axis 440.

According to various examples, extensions 430 and 435 are fabricated using an elastomeric material or polymer having a Young's modulus that is high enough to enable the retention and release element 410 or extensions 430 and 435 to flex or deflect to accommodate or secure an object, but low enough to retain the object through the arc of a swinging motion of the projectile throwing device until the apex or release point. Extensions 430 and 435 can flex or deflect in a direction 445 away from axis 440 to accommodate an object that is larger the distance 455 between the extensions in a relaxed or unflexed state. Extensions 430 and 435 can relax or return to a relaxed condition by contracting a direction 450 towards axis 440 after or responsive to releasing an object retained between the extensions.

In some examples, extensions 430 or 435, or collar 420 form an angle, such as the angle α (FIG. 2) with pug element 415.

In some examples, a relaxed distance between 455 between the second ends of extensions 430 and 435 is at least

$$2 \frac{1}{2}$$

of inches.

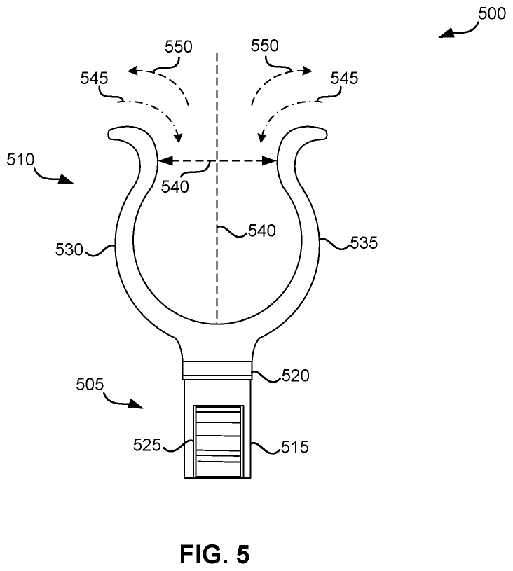

FIG. 5 illustrates an example of a base 500 of a projectile throwing device including an interchangeable projectile retention and release element 510 having at least two curved extensions 530 and 535 for securing a projectile. Projectile throwing device can be an example of any of the projectile throwing devices described herein, such as the projectile throwing device 100. As shown, base 500 can include a coupling element 505, corresponding to the coupling element 130, and projectile retention and release element 510 corresponding to projectile retention and release element 115. In an example, coupling element 505 includes plug element 515 or clip or button element 525. Projectile retention and release element 510, in various examples, include collar 520 and curved extensions 530 and 535. In an example, curved extensions 530 and 535 have first and second ends, where the first ends affix or couple the curved extensions to collar 520 and the second ends are distal ends of the extensions on opposing sides of a common or shared axis 540. In other examples, curved extensions 530 and 535 extend along a curved path (e.g., diverging from each other) on opposing sides of axis 440. In some examples, the curve of the curved extensions 530 and 535 is configured to accommodate or retain a soft or round object, such as a tennis ball or a stuffed toy (e.g., a stuffed animal or a size of beans of sand).

In other examples, the extensions 530 and 535 are fabricated using an elastomeric material or polymer having a Young's modulus that is high enough to enable projectile retention and release element 510 to flex or deflect to accommodate or secure an object, but low enough to retain the object through the arc of a swinging motion of the projectile throwing device until the apex or release point. Extensions 530 and 535 can flex or deflect in a direction 545 away from axis 540 to accommodate an object that is larger or wider than the distance between the extensions in a relaxed or un-flexed state. Extensions 530 and 535 can relax or return to a relaxed condition by contracting a direction 550 towards axis 540 after, or responsive to, releasing an object retained between the extensions.

In some examples, the extensions 530 or 535, or the collar 520 form an angle such as the angle α (FIG. 2) with the pug element 515.

In some examples, a relaxed distance between 540 between the second ends of the extensions 530 and 535 is

$$2 \frac{1}{2}$$

of inches.

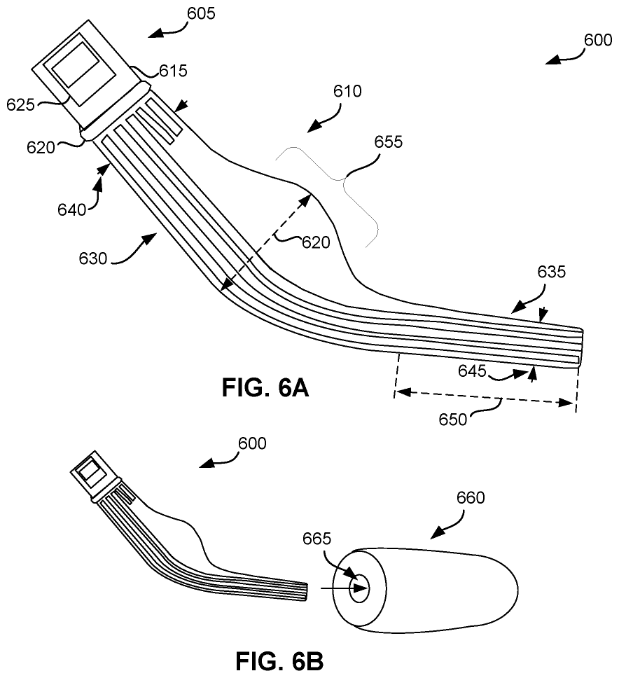

FIGS. 6A and 6B illustrate an example of a base 600 of a projectile throwing device including an interchangeable projectile retention and release element 610 having an angled extension for inserting into a projectile. The projectile throwing device can be an example of any of the projectile throwing devices described herein, such as the projectile throwing device 100. As shown, the base 600 can include a coupling element 605, corresponding to the coupling element 130, and projectile retention and release element 610 corresponding to projectile retention and release element 115. In an example, coupling element 605 includes plug element 615 or clip or button element 625. Projectile retention and release element 610, in various examples, include collar 620, and angled extension having a base extension 630 and a toe extension 630. In an example, base extension 630 has a width 640 of

$$1 \frac{1}{4}$$

inches and forms an angle, such as the angle α, with the toe extension 635. In an example, toe extension 635 includes a round, flat or rectangular tube having width 645 of

$$1 \frac{3}{4}$$

inches and a length 650 of 4 inches. Toe extension 635 is configured to be inserted into a cavity 670 of an object or toy, such as a Kong® toy, as shown in FIG. 6B. Projectile retention and release element 610, in various examples, includes a curved extension 655 having width 620 of

$$2 \frac{1}{2}$$

inches. Curved extension 655 can provide structural support for base 600 or may operate as a barrier to limit the depth to which toe extension 635 is inserted into object 660.

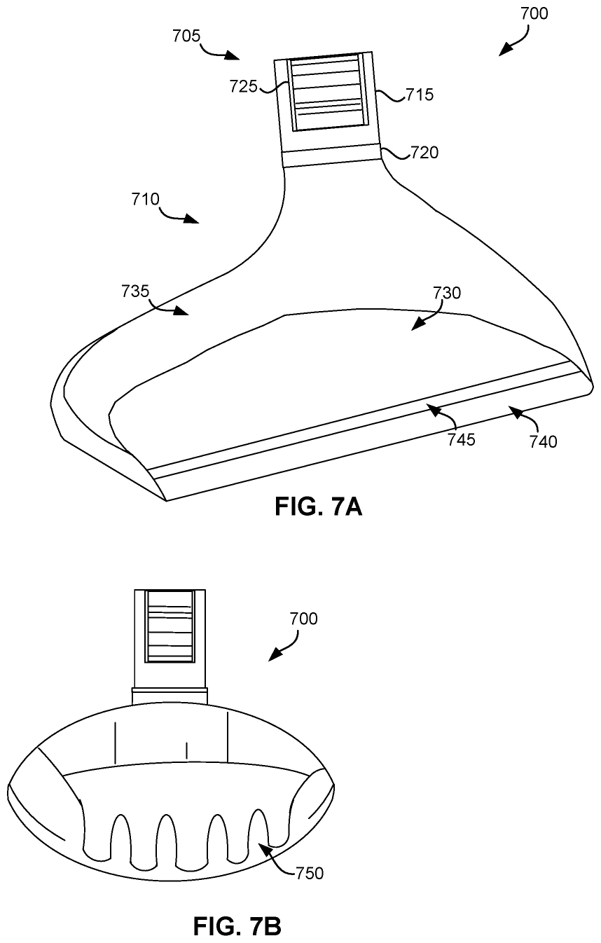

FIGS. 7A and 7B illustrates an example of a base 700 of a projectile throwing device including an interchangeable projectile retention and release element 710 having a scoop or cup region 730 for securing a projectile. The projectile throwing device can be an example of any of the projectile throwing devices described herein, such as the projectile throwing device 100. As shown, the base 700 can include a coupling element 705, corresponding to coupling element 130, and projectile retention and release element 710 corresponding to projectile retention and release element 115. In an example, coupling element 705 includes plug element 715 or clip or button element 725. Projectile retention and release element 710, in various examples, include collar 720, and cup region 730 having a base region 730 and walls 735. In some examples, cup region 730 further includes a lip or sloped region 740 that is configured to provide access to base region 730, such as for scooping balls, small toys, or other objects disposed on the ground. In some examples, the lip or sloped region 740 is sloped upward. In such examples, the sloped region 740 and at least a portion of the base region 735 can include one or more fingers 745, such as shown in FIG. 7B.

In some examples, cup region 730 includes a sloped or curved region 745. Sloped or curved region 745, in various examples, slopes down into the cup region 730, such as to from a bevelled edge with sloped region 740.

In some examples, cup region 730, walls 735 and lip region 740 or fingers 750 form a cup having a depth that is ½ to ¾ the depth of an indicated round object, such as tennis ball. The fingers 750, in some examples, curve under a portion of cup region 730.

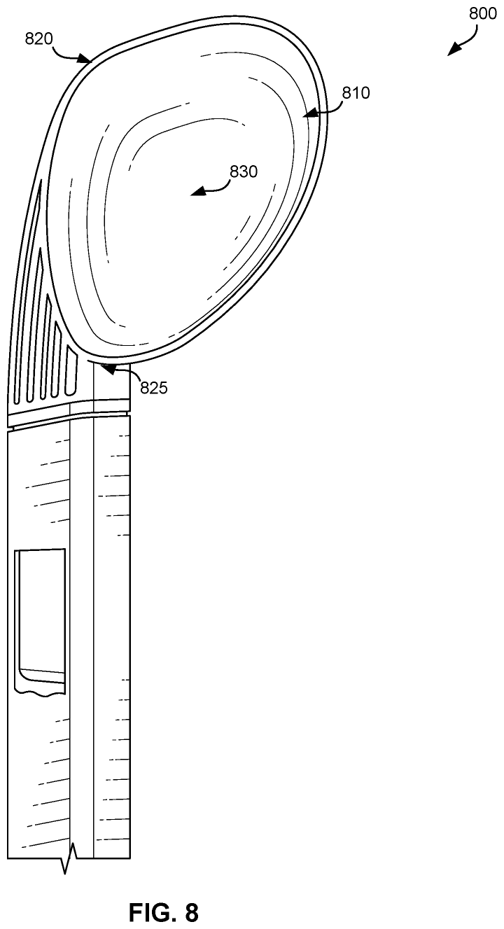

FIG. 8 illustrates an example of a model of a projectile throwing device 800. Example projectile throwing device 800 may include an interchangeable projectile retention and release element having a curved scoop 810 with one or more angled edges 820 825 for securing a round projectile. In an example, the curved scoop 810 includes a curved cavity 830 (e.g., cup region), which may have a curvature of ½ to ¾ of a tennis ball. In an example, the curved cavity 830 has a depth that is higher than the 50% axis point on a ball (e.g., more than half of the volume of a ball) to capture or retain the ball. The depth and shape of the curved cavity 830 may improve the ability to retain a ball within the curved scoop while allowing the ball to be launched from the example projectile throwing device 800.

### VARIOUS EXAMPLES

Example 1 is a projectile throwing device for any and all toys and tools the device comprising: a base having a coupler and a projectile retention and release element, wherein: the coupler comprises a first component of a latching element, the first component of the latching element configured to interface with a second component of the latching element to detachably couple the toy retainer to a handle, and the projectile handler comprises first and second flexible extensions which extend in a direction from the coupler, the first and second arms configured to elastically deflect from a shared axis responsive to a projectile inserted between the first and second extensions.

In Example 2, the subject matter of Example 1 includes the handle region.

In Example 3, the subject matter of Example 2 includes wherein the first and second extension, in a deflected state wherein the first and second extension are deflected from the axis, are configured to exert a retention force on the projectile that holds the projectile between the first and second extensions.

In Example 4, the subject matter of Example 3 includes wherein the first and second extensions are configured to release the projectile and return to a relaxed state responsive to a force exerted on the projectile that exceeds the retention force.

In Example 5, the subject matter of Examples 1˜4 includes wherein each extension of the first and second extensions includes a first end and a second end, wherein the first and second extensions are coupled together at their respective first ends, and respective second ends the first and second extensions are configured to elastically deflect from the axis responsive to a projectile inserted between the first and second extensions.

In Example 6, the subject matter of Example 5 includes wherein at least one extension of the first or second Extensions includes a substantially straight portion disposed between the first end and the second of the at least one extension.

In Example 7, the subject matter of Examples 5-6 includes wherein at least one extension of the first or second Extensions includes an arced portion disposed between the first end and the second of the at least one extension.

In Example 8, the subject matter of Examples 1-7 includes wherein the coupler forms an angle of at least 45 or degrees with the projectile Retention and release mechanism.

In Example 9, the subject matter of Examples 1-8 includes wherein the latching element includes a buckle, and the first and second components of the latching element include interlocking fittings of the buckle.

In Example 10, the subject matter of Examples 1-9 includes wherein the first and second components of the latching element include threaded fittings adapted to screw together.

In Example 11, the subject matter of Examples 1-10 includes wherein the latching element includes one or more threaded fittings adapted to fit a hole drilled through the handle and the retention and release mechanism collar to maintain/retain the retention and release mechanism in the handle.

In Example 12, the subject matter of Examples 1-11 includes wherein the first and second component of the latching element is configured to be depressed or rotated to detachably couple the base to a handle.

Example 13 is a projectile throwing device, the device comprising: a base having a collar and a projectile handler, wherein: the collar comprises a first component of a latching element, the first component of the latching element configured to interface with a second component of the latching element to detachably couple the base to a handle, and the projectile handler comprises a shank region and a toe region, the shank region having a proximate end coupled to the collar and a distal end coupled to the toe region, the toe region including an elongated portion extending from the shank and configured to be inserted into a projectile to hold the projectile to launch.

In Example 14, the subject matter of Example 13 includes wherein the projectile handler includes one or more rib structures that extend longitudinally along a length of the shank region and the toe region to resist flexing in the projectile handler.

In Example 15, the subject matter of Examples 13-14 includes wherein at least one of the shank region or the toe region forms an angle having at least 45 degrees with the collar.

In Example 16, the subject matter of Examples 13-15 includes wherein the toe region has a flat or a cylindrical cross-section.

In Example 17, the subject matter of Examples 13-16 includes wherein at least one of the shank region or the toe region includes a guard region configured to resist or limit insertion of the toe region into the projectile.

Example 18 is a projectile throwing device, the device comprising: a base having a collar and a projectile handler, wherein: the collar comprises a first component of a latching element, the first component of the latching element configured to interface with a second component of the latching element to detachably couple the base to a handle, and the projectile handler comprises a shaft region and a cup region, the shaft region having a proximal end coupled to the collar and a distal end coupled to the cup region, the cup region including: a base region to receive a projectile; bevelled sides that partially enclose the base region to secure the projectile within the base region; and an edge disposed between the bevelled sides and configured to provide a sloped surface for access to the base region.

Example 19 is at least one machine-readable medium including instructions that, when executed by processing circuitry, cause the processing circuitry to perform operations to implement of any of Examples 1-18.

Example 20 is an apparatus comprising means to implement of any of Examples 1-18.

Example 21 is a system to implement of any of Examples 1-18.

Example 22 is a method to implement of any of Examples 1-18.

The above detailed description includes references to the accompanying drawings, which form a part of the detailed description. The drawings show, by way of illustration, specific embodiments in which the inventive subject matter can be practiced. These embodiments are also referred to generally as “examples.” Such examples can include components in addition to those shown or described. However, the present inventors also contemplate examples in which only those components shown or described are provided. Moreover, the present inventors also contemplate examples using any combination or permutation of those components shown or described (or one or more aspects thereof), either with respect to a particular example (or one or more aspects thereof), or with respect to other examples (or one or more aspects thereof) shown or described herein. In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes components in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

As used herein, the term “connected” means a direct electrical connection between the things that are connected, without any intermediary devices. The term “coupled” includes either a direct electrical connection between the things that are connected, or an indirect connection through one or more passive or active intermediary devices. The term “circuit” corresponds to one or more passive and/or active components that are arranged to cooperate with one another to provide a desired function. The term “signal” at least one current signal, Voltage signal or data signal, such as an analog signal, a digital signal, or a mixed analog and digital signal.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the inventive subject matter should be determined with reference to the appended claims, along with the full scope of equivalents to which such claims are entitled.

What is claimed is:

1. A projectile throwing device for any and all toys and tools the device comprising:
a base having a coupler and a projectile retention and release element, wherein:
the coupler comprises a first component of a latching element, the first component of the latching element configured to interface with a second component of the latching element to detachably couple the toy retainer to a handle, and
the projectile handler comprises first and second flexible extensions which extend in a direction from the coupler, the first and second arms configured to elastically deflect from a shared axis responsive to a projectile inserted between the first and second extensions.

2. The device of claim 1, further comprising the handle region.

3. The device of claim 2, wherein the first and second extension, in a deflected state wherein the first and second extension are deflected from the axis, are configured to exert a retention force on the projectile that holds the projectile between the first and second extensions.

4. The device of claim 3, wherein the first and second extensions are configured to release the projectile and return to a relaxed state responsive to a force exerted on the projectile that exceeds the retention force.

5. The device of claim 1, wherein each extension of the first and second extensions includes a first end and a second end, wherein the first and second extensions are coupled together at their respective first ends, and respective second ends the first and second extensions are configured to elastically deflect from the axis responsive to a projectile inserted between the first and second extensions.

6. The device of claim 5, wherein at least one extension of the first or second Extensions includes a substantially straight portion disposed between the first end and the second of the at least one extension.

7. The device of claim 5, wherein at least one extension of the first or second Extensions includes an arced portion disposed between the first end and the second of the at least one extension.

8. The device of claim 1, wherein the coupler forms an angle of at least 45 or degrees with the projectile Retention and release mechanism.

9. The device of claim 1, wherein the latching element includes a buckle, and the first and second components of the latching element include interlocking fittings of the buckle.

10. The device of claim 1, wherein the first and second components of the latching element include threaded fittings adapted to screw together.

11. The device of claim 1, wherein the latching element includes one or more threaded fittings adapted to fit a hole drilled through the handle and the retention and release mechanism collar to maintain/retain the retention and release mechanism in the handle.

12. The device of claim 1, wherein the first and second component of the latching element is configured to be depressed or rotated to detachably couple the base to a handle.

13. A projectile throwing device, the device comprising:
a base having a collar and a projectile handler, wherein:
the collar comprises a first component of a latching element, the first component of the latching element configured to interface with a second component of the latching element to detachably couple the base to a handle, and
the projectile handler comprises a shank region and a toe region, the shank region having a proximate end coupled to the collar and a distal end coupled to the toe region, the toe region including an elongated portion extending from the shank and configured to be inserted into a projectile to hold the projectile to launch.

14. The device of claim 13, wherein the projectile handler includes one or more rib structures that extend longitudinally along a length of the shank region and the toe region to resist flexing in the projectile handler.

15. The device of claim 13, wherein at least one of the shank region or the toe region forms an angle having at least 45 degrees with the collar.

16. The device of claim 13, wherein the toe region has a flat or a cylindrical cross-section.

17. The device of claim 13, wherein at least one of the shank region or the toe region includes a guard region configured to resist or limit insertion of the toe region into the projectile.

18. A projectile throwing device, the device comprising:
a base having a collar and a projectile handler, wherein:
the collar comprises a first component of a latching element, the first component of the latching element configured to interface with a second component of the latching element to detachably couple the base to a handle, and
the projectile handler comprises a shaft region and a cup region, the shaft region having a proximal end coupled to the collar and a distal end coupled to the cup region, the cup region including:
a base region to receive a projectile;
beveled sides that partially enclose the base region to secure the projectile within the base region; and
an edge disposed between the beveled sides and configured to provide a sloped surface for access to the base region.
